(19) United States
(12) Patent Application Publication
(10) Pub. No.: US 2016/0068375 A1
(43) Pub. Date: Mar. 10, 2016

(54) CRANE BOOM AND CRANE

(71) Applicant: LIEBHERR-WERK BIBERACH GMBH, Biberach an der Riß (DE)

(72) Inventor: Guenter LEHNER, Ummendorf (DE)

(21) Appl. No.: 14/779,316

(22) PCT Filed: Mar. 19, 2014
(86) PCT No.: PCT/EP2014/000751

§ 371 Date: Sep. 22, 2015

(30) Foreign Application Priority Data
Mar. 22, 2013 (DE) 10 2013 005 052.9

(51) Int. Cl. B66C 23/68; B66C 7/06

(52) U.S. Cl. CPC B66C 23/68; B66C 7/06

(57) ABSTRACT

The invention relates to a crane boom for a crane comprising an upper web and two lower webs which are connected to one another by means of a lattice and form a triangular boom cross-section, wherein the boom cross-section comprises a triangular cross-sectional shape at least sectionally with an upper web extending off center. The invention furthermore relates to a crane having such a crane boom.

The invention relates to a crane boom for a crane having a triangular boom cross-section and to a crane having such a boom.

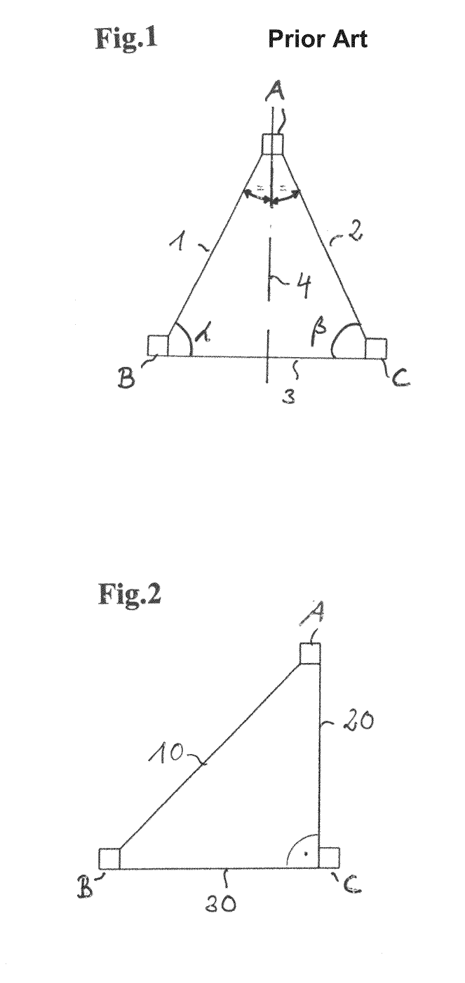

The invention starts from proven and torsionally rigid booms having a triangular cross-section. For illustration, FIG. 1 shows a sketch representation of a conventional boom cross-section. This boom comprises the two lower webs B, C and the upper web A. All the webs are connected to one another via half-timber diagonal braces, the so-called lattice.

The standard triangular cross-sections are, starting from the upper web A, an isosceles triangle whose sides A-B (triangle side 1) and A-C (triangle side 2) have identical lengths. The upper web A is therefore above half the side B-C (triangle side 3) between the lower webs B and C. The bisectrix 4 crosses the line B-C centrally. In addition, the angles α, β of the lower webs B, C are identical or almost identical.

It is desirable for the transport from and to the deployment site with such cranes to reduce their geometrical dimensioning as much as possible for the road transport in order, for example, to correspond to the rules of the road traffic regulations and to reduce the transport costs incurred. Different solution variants can be found for this purpose in the prior art. For example, the total boom cross-section is thus reduced so much until the geometrical dimension satisfies the requirements of road transport. This procedure can, however, result in boom cross-sections which are unfavorably small statically and are thereby heavy and elastic.

A crane is known from DE 20 42 335 having two boom parts which are pivoted toward one another about a horizontal axis to reduce the transport height. However, the boom parts first have to be displaced toward one another in an axial direction prior to the pivoting. This increases the effort and possibly requires additional equipment components such as a motor-driven pushing drive. The greatest disadvantage is, however, that no satisfactory minimization of the incurred space requirement is achieved by the conventional boom shape.

It is furthermore known to configure boom parts to be positioned with respect to one another at least partly as a so-called “open U” with a fast-erecting crane. The boom part formed as an “open U” receives the folded in boom region in the formed inner space of the “U shape”, whereby the total transport height can be reduced.

The U shape of the boom system, however, brings along some disadvantages with respect to the conventional triangular shape. The U shape in particular makes two upper webs necessary, which results in an increase of the boom weight and an increase of the manufacturing costs. Open cross-sections are furthermore extremely torsionally soft. They can only be used with fast-erecting cranes in those boom regions which are only exposed to small torsion forces, e.g. caused by wind, during the crane operation or the crane erection. As a consequence, there is a threat of a restriction of the maximum permitted wind velocities during crane operation or during the crane erection, which would counteract the deployment flexibility of such cranes.

An alternative boom design as a telescopic boom is cost-intensive and generates an added weight, in particular by the boom parts overlapping in the telescopic connection. The actually present boom length can furthermore not be ideally utilized due to the overlapping. In addition, special measures for the use of a trolley operation have to be taken with telescopic booms since different telescopic sections, for example, require a change of track of the trolley.

It is therefore the object of the present invention to further develop a crane of the category such that it can be positioned more compactly with respect to the transport height and/or to the transport width and since additionally no noticeable impairment of the proven and torsionally rigid boom cross-section has to be accepted.

This object is achieved by a crane boom in accordance with the features of claim 1. Further advantageous embodiments of the crane boom in accordance with the invention are the subject of the dependent claims.

In accordance with claim 1, a modified boom cross-section is proposed, whereby two boom parts can be nested with one another to be positioned more compactly with respect to one another either in the transport height and/or in the transport width. The crane boom has two lower webs and an upper web which are connected to one another by means of a lattice and form a triangular cross-sectional shape. The modified cross-sectional boom shape has a triangular cross-sectional shape at least sectionally with an upper web extending off-center. The formed triangular shape consequently no longer corresponds to an isosceles triangle. The upper web does not lie on the median of the triangle side connecting the lower webs, but rather moves more closely in the direction of one of the two lower webs.

The greatest space saving on the crane transport results when the crane boom has a right-angled or almost right-angled triangular shape at least sectionally.

Two boom parts can be nested with one another with this modified cross-sectional shape such that in the most favorable case the transport dimensions, in particular with respect to the height and/or width of the boom, are only negligibly larger than if only one boom part were to be transported. The prescribed or desired transport heights and/or transport widths can hereby be observed more easily or more boom parts can be accommodated in the same space.

Ideally, at least those boom regions have the boom cross-sectional shape in accordance with the invention which are to be positioned next to one another or on one another for the transport.

At least two boom parts are in particular nested with one another or positioned next to one another such that their longest triangle sides or, in the case of a right-angled triangle, their hypotenuses are laid next to one another.

In a particularly advantageous embodiment of the invention, the longest triangle side or the hypotenuse of the boom cross-section connects the upper web to a lower web of the crane boom. Consequently, the remaining triangle sides connect the upper web to the remaining lower web and the two lower webs to one another. A leg of the formed triangular shape in particular leads from the upper web to the remaining lower web and the second leg connects the two lower webs of the boom. In this advantageous construction, the upper web is located approximately perpendicular above one of the lower webs of the triangle shape. The connection of the upper web over the hypotenuse can selectively take place by the first or second lower web.

In accordance with a first embodiment, the crane boom comprises at least two boom pieces which can be dismantled for the road transport or for the storage of the boom. The at least two boom pieces can therefore be positioned nested with one another such that in the most favorable case the transport dimensions are only negligibly larger with respect to the dimension of an individual boom part. Prescribed or desired transport heights or transport widths can be observed more easily and more boom parts can be accommodated in the same space. This applies equally to road transport where in particular statutory provisions have to be observed and also to container transport where the maximum highest dimension is frequently limited.

It is proposed as a sensible further embodiment of the invention that at least two boom regions are pivotably supported with respect to one another about a pivot axis, in particular about a horizontal pivot axis. Both boom regions can hereby be pivoted with respect to one another or folded onto one another to be able to minimize the resulting transport dimension of the crane during road transport.

In the best case, the at least two boom regions can be pivoted about almost 180° with respect to one another, whereby the pivot regions can be placed laterally next to one another or above one another for the crane transport, with in particular their longest triangle sides or hypotenuses being able to be laid next to one another.

The upper webs of the at least two boom regions ideally extend laterally offset with respect to one another during the crane operation. The boom regions are particularly preferably designed as mirror-inverted, i.e. the longest triangle sides or hypotenuses of the boom regions connect different lower webs to the upper web. The possibility is hereby produced that these two boom regions are pivotable toward one another by 180° for the transport, with mutually offset upper boom webs, and can be laid next to one another such that the resulting cross-sectional shape and thus in particular the height in nested boom sections is only insignificantly increased with respect to the dimension of an individual boom part during transport. Such an advantageous design of the crane boom in particular has the result that both boom regions can be pivoted toward one another such that the longest triangle sides or hypotenuses of the respective boom cross-sections lie next to one another.

Depending on the desired height reduction, the horizontally oriented pivot axis is arranged in the region between half the system height of the crane boom and the plane of the upper web. The boom parts can thereby only be positioned with respect to one another for the transport in the sense of this invention by the pivoting of this axis.

The crane boom in accordance with the invention is naturally not reduced to such a modified boom cross-section. There is, for example, a combination possibility of the most varied boom cross-sections with the boom shape in accordance with the invention. The boom can, for example, be designed, in addition to a section with the shape in accordance with the invention, with at least one boom region forming an isosceles triangular cross-sectional shape. The transition between different boom sections with different boom cross-sections may make the integration of one or more transition pieces necessary under certain circumstances.

The solution in accordance with the invention allows the integration of a trolley operation at the boom in a simple manner. It can be advantageous for this purpose if the two lower webs form a trolley track.

The invention furthermore relates to a crane, in particular to a fast-erection crane or a top-slewing crane, having a crane boom in accordance with the present invention or with an advantageous embodiment of the invention. The same advantages and properties as for the crane boom in accordance with the invention obviously apply to the crane in accordance with the invention so that a repeat description will be dispensed with here.

Further advantages and details of the invention result from the embodiments shown in more detail in the drawings. There are shown:

FIG. 1: a sketch of the triangular cross-section of a crane boom known from the prior art;

FIG. 2: a sketch of the triangular cross-section for a crane boom in accordance with the invention;

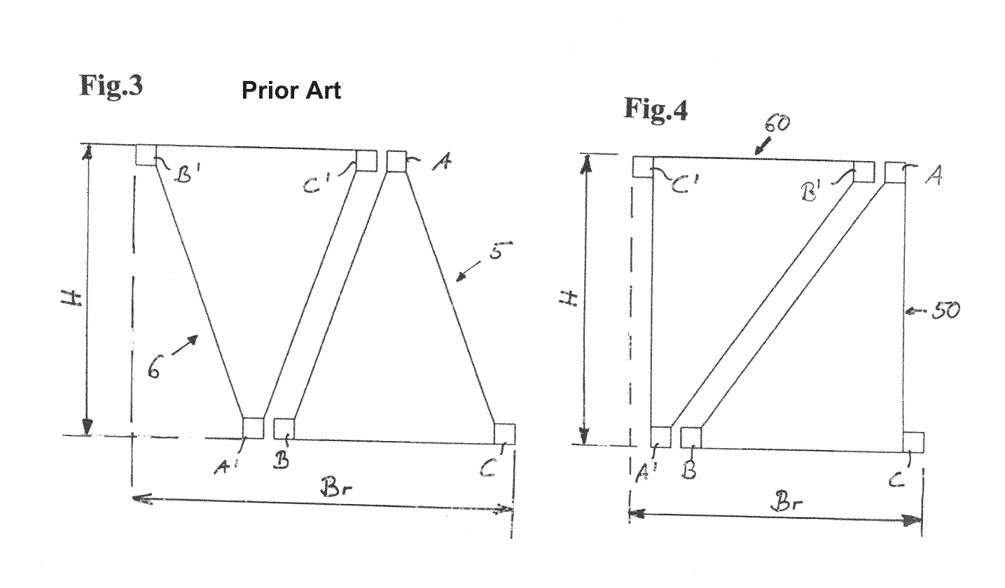

FIG. 3: a sketched representation of two boom parts known from the prior art during the crane transport;

FIG. 4: a sketched representation of two crane boom parts in accordance with the invention during the crane transport;

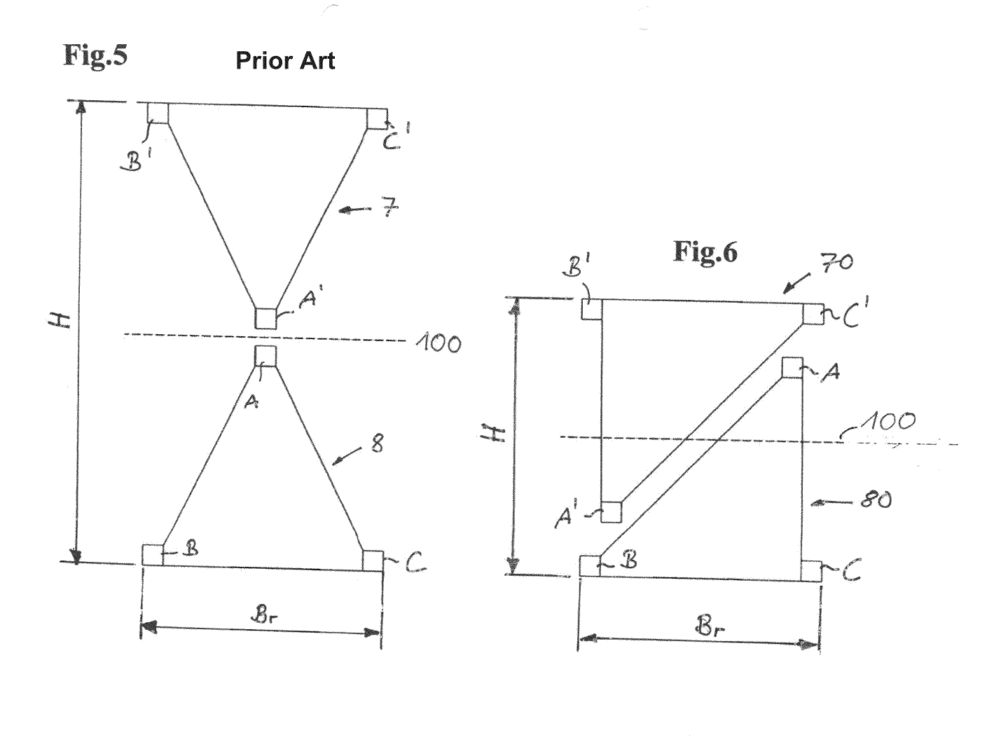

FIG. 5: a sketch-like representation of the folded-together crane boom of a fast-erection crane in accordance with the prior art:

FIG. 6: a sketch-like representation of the folded-together crane boom of a fast-erection crane in accordance with the invention;

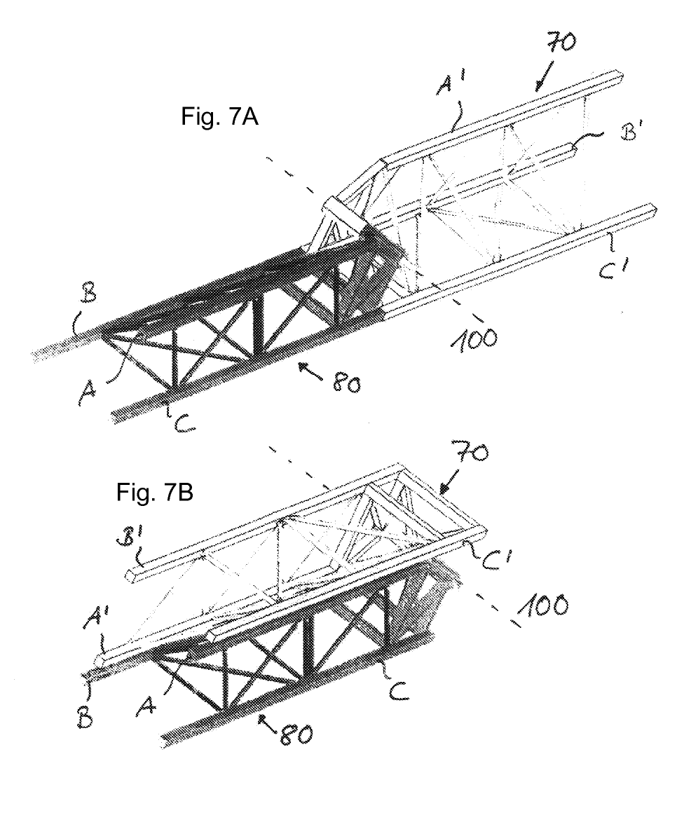

FIG. 7: perspective detailed shots of the crane boom in accordance with the invention for a fast-erection crane;

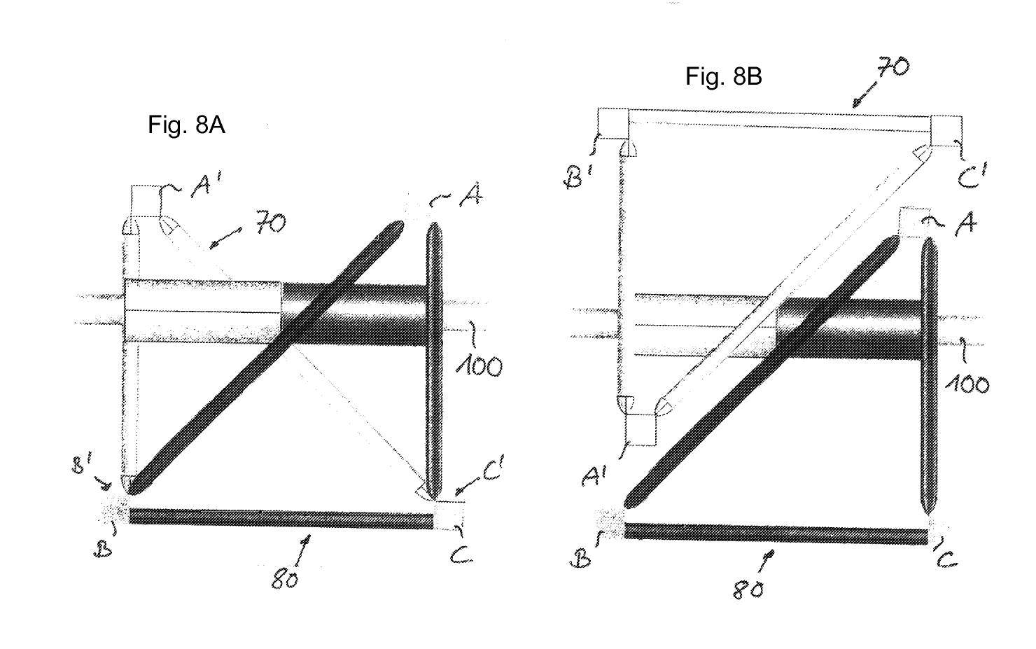

FIG. 8: detailed cross-sectional representations of the crane boom in accordance with the invention of FIG. 7 for a fast-erection crane:

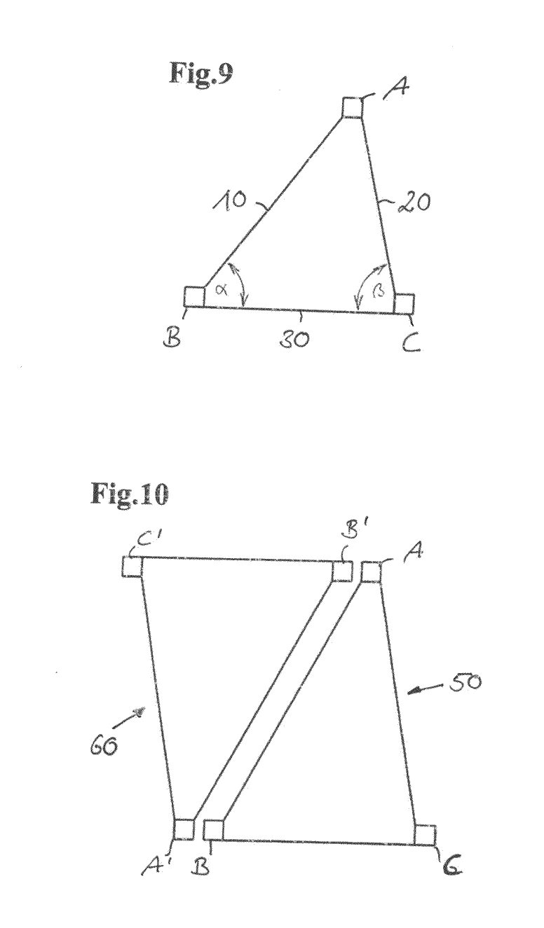

FIG. 9: a sketch of the triangular cross-section for a crane boom in accordance with the invention in accordance with an alternative embodiment;

FIG. 10: a sketched representation of two crane boom parts in accordance with the invention in accordance with FIG. 9 during the crane transport; and

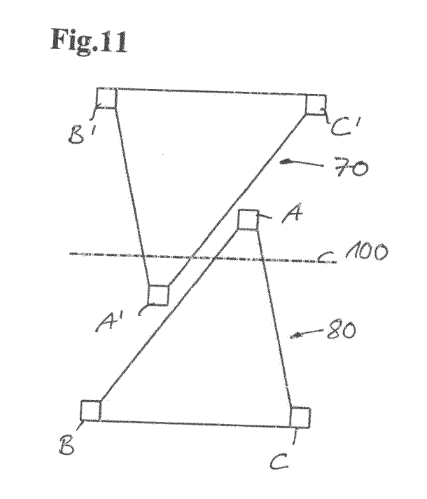

FIG. 11: a sketch-like representation of a folded-together crane boom in accordance with the invention of a fast-erection crane in accordance with an alternative embodiment comprising crane boom parts in accordance with FIG. 9.

Reference has already been made to FIG. 1 in detail in the introductory part so that no repeat explanation will take place at this point. FIG. 2 shows in contrast a sketched cross-sectional representation of the crane boom in accordance with the invention which is characterized by a modified triangular cross-section.

The invention starts from the proven and torsionally rigid boom structure having a triangular cross-section. Analog to the prior art, this boom shape has two lower webs B, C and an upper web A, wherein all webs are connected to one another by means of half-timber diagonal braces, the so-called lattice.

Unlike the embodiment of FIG. 1, the modified boom cross-section does not form an isosceles triangle, but rather a right-angled or approximately right-angled triangle having the webs A. B and C as corners. A first leg as the side A-C (triangle side 20) extends from the upper web A to the lower web C, while the second leg as the side B-C (triangle side 30) extends from the lower web B to the lower web C. The side A-B (triangle side 10) then forms a hypotenuse from the upper web A to the second lower web B. The upper web A is consequently located approximately perpendicular above the lower web C. The right angle is located at the lower web C.

The boom shape in accordance with the invention is naturally not restricted to the representation in accordance with FIG. 2. The design of the boom can just as easily also be inverted so that the hypotenuse is formed by the side AC.

Two boom parts can be nested with one another using this cross-sectional shape such that in the most favorable case the transport dimension is only negligibly larger with respect to its height and width than if only one boom part is transported. Reference is made to the Figure representation of FIGS. 3 and 4 for the illustration of this advantage. Both Figures show a crane boom which comprises at least two separate boom parts 5, 6, 50, 60 which are dismantled for the crane transport and are positioned next to one another on a conveying means, not shown.

FIG. 3 corresponds in this respect to a crane boom known from the prior art having the typical triangular cross-section. The representation shows a cross-section through the longitudinal axis of the boom parts 5, 6 positioned next to one another. A first boom part 5 is in this respect placed with its lower webs B, C onto the transport surface of the transport means, whereas the second boom part 6 is placed, rotated about its longitudinal axis, with the upper web A′ onto the transport surface. As can be seen from FIG. 3, the transport width Br increases by at least more than half the system width of the boom pieces 5, 6.

FIG. 4 shows the advantages of the cross-sectional surface in accordance with the invention of the boom in accordance with the invention. The boom or individual lattice pieces of the boom have the same construction height and construction width as the boom in accordance with FIG. 3 in crane operation. Due to the right-angled triangular cross-sectional surface, however, the hypotenuses (sides AC and A′-C′) of the two boom parts 50, 60 can be placed onto one another so that neither the transport height H nor the transport width Br is substantially increased in size with respect to the geometrical dimension of an individual boom piece 50, 60. The prescribed or desired transport heights or transport widths can hereby be observed more easily or more boom parts can be accommodated in the same space. The same applies accordingly to road transport which is bound by statutory provisions and also to container transport to which maximum highest dimensions often apply.

Another embodiment can be seen from FIGS. 5 and 6 which each show sketched cross-sectional representations through two boom parts of a crane boom folded toward one another for a fast-erection crane. With this crane, the crane boom or at least two crane boom parts can be pivoted with respect to one another about a horizontally extending pivot axis 100 for the transport from and to the deployment site such that they are folded onto one another during the crane transport to reduce the total crane length.

FIG. 5 in this respect shows a schematic representation of a typical crane boom whose cross-section has an isosceles triangle. The crane boom tip 7 is in this respect folded upward and to the rear by 180° about the pivot axis 100 with respect to the remaining fixed-position crane boom part 8 so that the two crane boom parts 7, 8 lie on one another. The two upper webs A, A′ of the crane boom parts 7, 8 in particular extend in parallel and lie on one another. As can furthermore be seen from FIG. 5, the transport height H of the resulting folded-together crane boom is thereby at least doubled by the system height of the individual crane boom part 7, 8.

In contrast, a considerable gain in space can be achieved by the modified boom cross-section of a fast-erection crane in accordance with FIG. 6. The boom or individual lattice pieces here also have the same construction height and construction width as the boom in accordance with FIG. 5 in crane operation. However, due to the modified boom cross-section, the total transport height H is only negligibly increased in size with respect to an individual boom part 70, 80. The resulting transport width also remains almost unaffected by this.

Analog to FIG. 5, the boom tip 70 is here also folded by 180° upwardly or to the rear about a horizontally extending pivot axis 100. The hypotenuses (sides A-B, A′-C′) of the boom cross-sections of both boom parts 70, 80 lie next to one another, similar to the representation in accordance with FIG. 4.

To achieve the best possible gain in space for the transport, the two boom parts 70, 80 to be nested for transport are connected to mutually offset upper boom webs A, A′ in the operating position. Both boom segments 70, 80 are of a mirror-inverted design for this purpose, i.e. the hypotenuse is formed by the side A′-C′ at the boom tip 70, whereas the side A-B represents the hypotenuse at the boom part 80.

The horizontal offset of the upper webs A, A′ during the crane operation is illustrated in FIGS. 7a, 7b or 8a, 8b. FIG. 7a shows the crane boom in accordance with the invention in a perspective side view during the operating position and FIG. 7b shows a perspective side view of the boom in the transport position. FIGS. 8a, 8b show cross-sectional representations of the crane boom associated with FIGS. 7a, 7b in the region of the pivot axis 100.

The arrangement of the horizontal pivot axis 100 can be arranged in dependence on the desired height reduction between half the system height of the boom 80 and the plane of the upper web A. The boom parts 70, 80 can thereby only be positioned with respect to one another for the transport in the sense of this invention by the pivoting about the axis 100.

FIGS. 9, 10 and 11 show an alternative embodiment of the crane boom in accordance with the invention. Unlike in the embodiment in accordance with the invention in accordance with FIGS. 2, 4 and 6 to 8, it is not a triangular shape which is selected, but rather an intermediate shape between an isosceles triangle and a right-angled or almost right-angled triangle. The angle ratio of the angles α and β in the lower webs is adapted such that the upper web A lies off-center, i.e. does not lie on the median of the triangle side B-C. In the embodiment of FIG. 9, the angles are selected according to the following rule

α<β<90°.

The greater the angular difference between the angles α and β, the greater the space saving during the crane transport or on the dismantling of a fast-erection crane. Alternatively, the angle α can also be dimensioned larger with respect to the angle β.

FIGS. 10, 11 show the alternative boom embodiment in accordance with FIG. 9 during the road transport analog to FIG. 4 and in the folded-together state analog to FIG. 6. This alternative embodiment does not produce a fully optimal space utilization, in particular with respect to the resulting height dimension, during the transport state; however, this cross-sectional shape can be sufficient for many areas of application since a satisfactory gain of space is possible with respect to the solution known from the prior art. The presented solution can furthermore have construction advantages with respect to the boom static over the right-angled triangle shape.

1. A crane boom for a crane comprising an upper web and two lower webs which are connected to one another by means of a lattice and form a triangular boom cross-section,
wherein the boom cross-section comprises a triangular cross-sectional shape at least sectionally with the upper web extending off-center.

2. The crane boom in accordance with claim 1, wherein the triangular boom cross-section is at least sectionally right-angled or almost right-angled.

3. The crane boom in accordance with claim 1, wherein a longest triangle side of the boom cross-section, wherein the longest triangle side is a hypotenuse, connects the upper web to a lower web of the crane boom.

4. The crane boom in accordance with claim 1, wherein the boom comprises two or more boom pieces which are dismantlable for road transport.

5. The crane boom in accordance with claim 1, wherein at least two boom regions are supported pivotably with respect to one another about a pivot axis, wherein the pivot axis is a horizontal pivot axis.

6. The crane boom in accordance with claim 5, wherein the at least two boom regions are pivotable by 180° with respect to one another, whereby longest triangle sides of the boom regions, are placed laterally next to one another.

7. The crane boom in accordance with claim 5, wherein upper webs of the at least two boom regions extend laterally offset from one another.

8. The crane boom in accordance with claim 5, wherein the pivot axis is arranged in a region between half a system height of the boom and a plane of the upper web.

9. The crane boom in accordance with claim 1, wherein the boom comprises at least one boom region having a boom cross-section forming an isosceles triangle, with boom sections having different boom cross-sections optionally being connected to one another by means of a transition piece.

10. The crane boom in accordance with claim 1, wherein lower webs of the boom form a trolley track.

11. A crane having the crane boom in accordance with claim 1, wherein the crane is a fast erection crane or a top slewing crane.
